(19) United States
(12) Patent Application Publication
(10) Pub. No.: US 2010/0003094 A1
(43) Pub. Date: Jan. 7, 2010

(54) DRILL BIT

(75) Inventor: LaVerne R. Durfee, Harmony, NC (US)

Correspondence Address: MOORE & VAN ALLEN PLLC, P.O. BOX 13706, Research Triangle Park, NC, 27709, US

(73) Assignee: IRWIN INDUSTRIAL TOOL COMPANY, Huntersville, NC (US)

(21) Appl. No.: 12/555,364

(22) Filed: Sep. 8, 2009

Related U.S. Application Data
(63) Continuation-in-part of application No. 11/621,308, filed on Jan. 9, 2007.

(51) Int. Cl. B27G 15/00; B23B 51/02; B21K 5/04

(52) U.S. Cl. 408/144; 408/214; 76/108.6; 408/231

(57) ABSTRACT

A cutting head is formed at one end of the shank and comprises a cylindrical member having an annular wall defining a circular cutting edge. A cutting blade having a sharp cutting edge extends from adjacent a centering point to adjacent the cutting edge. The cutting head is formed of a first material and the cutting blade is formed of a second material. The cutting blade is brazed to the cutting head. A method of making a drill bit comprises investment casting a shank and a cutting head of a first material. A pocket is formed that extends to the cutting edge. A coupon of a second material is brazed in the pocket. A sharp edge is ground in the coupon.

This application this application is a continuation-in-part of prior application Ser. No. 11/621,308, filed Jan. 9, 2007, which is incorporated herein by reference in its entirety.

The invention relates generally to wood boring tools and more particularly to drill bits.

### BACKGROUND OF THE INVENTION

Drill bits for boring holes of preselected diameters in a workpiece are known. Such bits come in a variety of styles. One type of bit is known as a wood auger. This type of bit includes a shank that has one end adapted to be connected to a chuck of a rotary tool such as a drill or power driver. The opposite end of the shank supports a wood auger that comprises a flute that terminates in a cutting face for cutting a bore in the workpiece. The cutting member may also be formed with a pilot point along its longitudinal axis for guiding the bit into and through the workpiece. Another type of bit is known as a spade bit or paddle bit. This type of bit includes a shank that has one end adapted to be releasably connected to a chuck of a rotary tool such as a drill or driver. The opposite end of the shank supports a cutting member where the cutting member is a substantially flat, relatively thin blade. Yet another type of bit is a fluted bit that has a plurality of flutes formed in spirals around the longitudinal axis of the bit. The flutes define cutting edges for cutting the workpiece. Still another type of bit is a self-feed bit that has a cutting head formed on one end of a shank. The cutting head comprises an annular wall connected to shank that defines a circular cutting edge such that as the drill bit rotates the wall circumscribes and cuts a round hole. A cutting blade having a sharp cutting edge is formed on the cutting head to remove material from the interior of the cutting head.

While various types of drill bits are known, an improved wood bit is desired.

### SUMMARY OF THE INVENTION

The drill bit comprises a shank defining a longitudinal axis. A cutting head is formed at one end of the shank and comprises a cylindrical member having an annular wall defining a circular cutting edge including a plurality of teeth. A centering point is formed along the longitudinal axis. A cutting blade having a sharp cutting edge extends from adjacent the centering point to adjacent the cutting edge. The cutting head is formed of a first material and the cutting blade is formed of a second material. The cutting blade is brazed to the cutting head. The second material may be harder than the first material. The shank and cutting head may be investment cast. The cutting head may be made of an alloyed carbon steel that can be heated to approximately 35 HRC. A pocket may extend between the center of the bit and the cutting edge for receiving the cutting blade. The cutting blade may be formed of an alloyed steel capable of achieving approximately 60 HRC such as HSS. A filler alloy may join the cutting blade to the cutting head.

A method of making a drill bit comprises investment casting a shank and a cutting head of a first material where the cutting head comprises a cylindrical member having an annular wall defining a circular cutting edge including a plurality of teeth. A pocket is formed that extends to the cutting edge. A coupon of a second material is brazed in the pocket. A sharp edge is ground in the coupon.

### BRIEF DESCRIPTION OF THE DRAWINGS

FIG. 1 is a side view of one embodiment of the drill bit of the invention.

FIG. 2 is a schematic drawing illustrating the major manufacturing processes for making the drill bit of the invention.

FIG. 3 is a side view of another embodiment of the drill bit of the invention.

FIG. 4 is a side view of yet another embodiment of the drill bit of the invention.

FIG. 5 is a flow chart illustrating one embodiment of a method of manufacturing the bit of the invention.

FIG. 6 is a perspective view showing still another embodiment of the drill bit of the invention.

FIG. 7 is a partial perspective view showing the embodiment of the drill bit of FIG. 6 without the cutting blade.

FIG. 8 is a partial perspective view showing the embodiment of the drill bit of FIG. 6 with the coupon.

FIG. 9 is a flow chart illustrating another embodiment of a method of manufacturing the bit of the invention.

### DETAILED DESCRIPTION OF EMBODIMENTS OF THE INVENTION

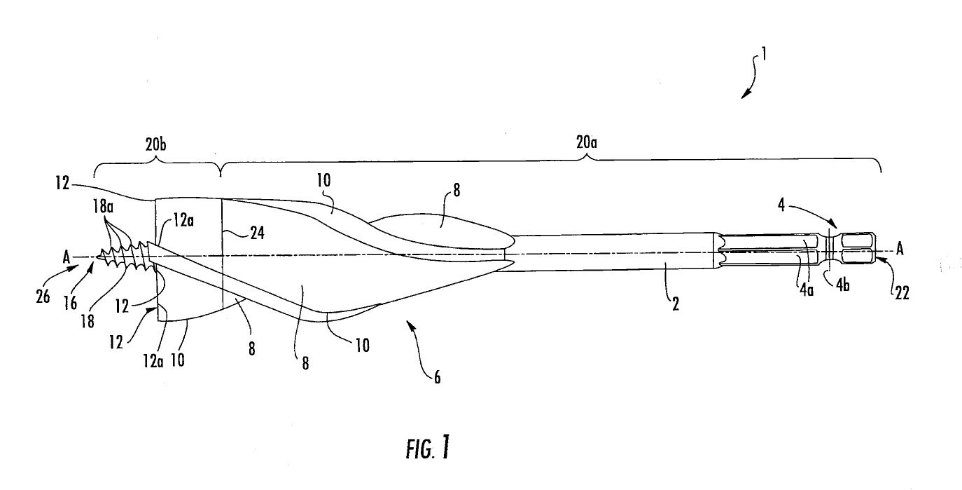

Referring to FIG. 1 an embodiment of a bi-metal drill bit is shown generally at 1 and comprises a shank 2 having a quick coupling 4 disposed at a first end thereof. The quick connect coupling 4 may comprise a plurality flat faces 4a adapted to be received and retained in a chuck of a rotary tool such as a screwdriver or power driver. A recess 4b may be formed around the circumference of the shank to be releasably engaged by the quick connect coupler of the rotary tool. Other configurations of shank 2 may also be used for coupling the drill bit to a rotary drive tool.

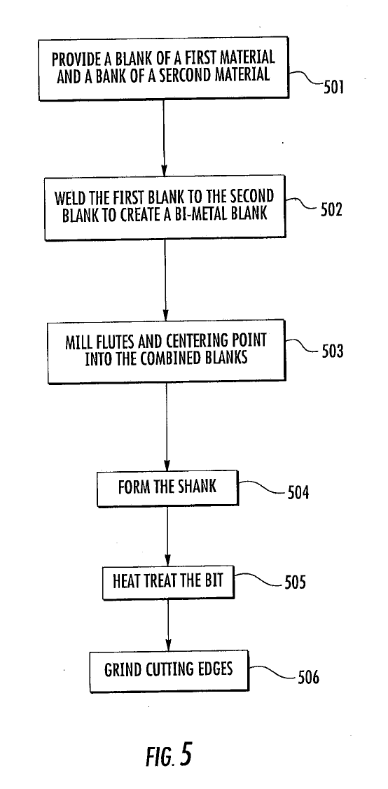

A cutting head 6 is formed on the opposite end of shank 2 from quick connect coupling 4. The cutting head 6 is intended to cut wood and may include a plurality of flutes 8 defining a plurality of ribs 10 therebetween. In the embodiment of FIG. 1 three flutes and ribs are shown although the cutting head may have a different number flutes and a variety of designs. Each rib 10 has a cutting face 12 formed at the distal end thereof. The cutting face typically extends from the side edges of ribs 10 to a centering or pilot point 16 located along the longitudinal axis A-A of the drill bit. In the illustrated embodiment the centering point 16 is a lead screw 18 having threads 18a for centering the bit and feeding the bit through the wood. The lead screw 18 may be replaced by a lead point as shown in FIG. 4. The centering point 16 may be made removable such that a broken point may be replaced. With a replaceable centering point the centering point would preferably be made out of high speed steel (HSS) as a separate component. Each cutting face 12 may be formed with a bevel angle to create a sharp cutting edge 12a on each of the ribs for cutting the material as the drill bit rotates.

The drill bit 1 is formed of at least two different portions made of different materials permanently joined together to create a unitary single piece drill bit. The first portion 20a is formed of a first material such as 1065 carbon steel. The first portion 20a extends from the proximal end 22 of the bit to a weld line 24. The second portion 20b is formed of a second material such as high speed steel (HSS). The second portion 20b extends from the distal end 26 of the bit to weld line 24 and includes the cutting edges 12a and centering point 16. In one embodiment the weld line 24 is located in the cutting head 6 such that the flutes 8 and ribs 10 have a first portion that is formed of the first material and a second portion that is formed of the second material. In one embodiment the size of the second portion is determined to minimize the amount of HSS used yet allow a good weld between the first portion and the second portion. The second material that makes up the cutting edges and centering point is harder and/or stronger than the first material. While weld line 24 is shown in FIG. 1 to illustrate the weld between the first portion 20a and second portion 20b, the transition between these portions is smooth, uniform and uninterrupted such that the first portion transitions smoothly into the second portion.

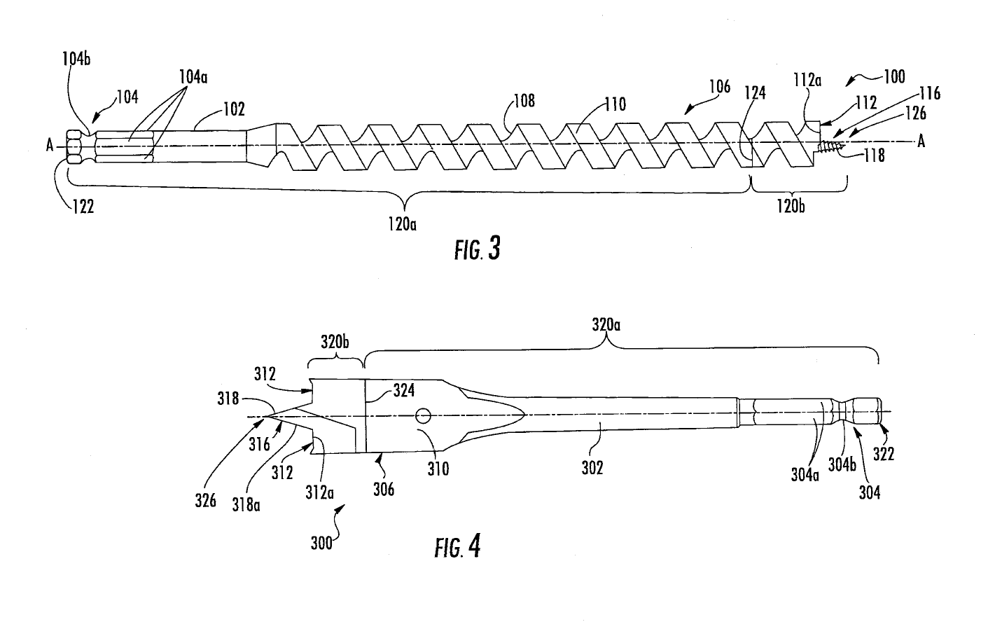

A second embodiment of a drill bit is shown in FIG. 3 comprising a single flute wood auger 100. Wood auger 100 comprises a shank 102 having a quick coupling 104 disposed at a first end thereof. The quick connect coupling 104 may comprise a plurality flat faces 104a and a recess 104b, as previously described, that may be releasably engaged by the quick connect coupler of the rotary tool.

A cutting head 106 is formed on the opposite end of shank 102 from quick connect coupling 104. The cutting head 106 is intended to cut wood and may include a single flute 108 defining a rib 110. Rib 110 has a cutting face 112 formed at the distal end thereof. The cutting face 112 typically extends from the side edge of rib 110 to a centering or pilot point 116 located along the longitudinal axis A-A of the auger. In the illustrated embodiment the centering point 116 is a lead screw 118 having threads for centering the auger and feeding the auger through the wood. The lead screw 118 may be replaced by a lead point as shown in FIG. 4. The lead screw may also be made detachable as previously described. Cutting face 112 is formed with a bevel angle to create a sharp cutting edge 112a for cutting the material as the auger rotates.

The auger is formed of at least two different portions made of different materials permanently joined together to create a unitary, single piece auger. The first portion 120a is formed of a first material such as 1065 carbon steel. The first portion 120a extends from the proximal end 122 of the auger to a weld line 124. The second portion 120b is formed of a second material such as high speed steel (HSS). The second portion 120b extends from the distal end 126 of the auger to weld line 124 and includes the cutting edge 112a and centering point 116. In one embodiment the weld line 124 is located in a central portion of the cutting head 106 such that a first portion of the flute and rib are formed of the first material and a second portion of the flute 108 and rib 110 are formed of the second material. In one embodiment the second material that includes the cutting edges and centering point is harder and/or stronger than the first material. While weld line 124 is shown in FIG. 3 to illustrate the weld between the first portion 120a and second portion 120b, the transition between these portions is smooth, uniform and uninterrupted such that the first portion transitions smoothly into the second portion.

A third embodiment of a drill bit is shown in FIG. 4 comprising a spade bit 300. Spade bit 300 comprises a shank 302 having a quick coupling 304 disposed at a first end thereof. The quick connect coupling 304 may comprise a plurality flat faces 304a and a recess 304b, as previously described, that may be releasably engaged by the quick connect coupler of the rotary tool.

A cutting head 306 is formed on the opposite end of shank 302 from quick connect coupling 304. The cutting head 306 is intended to cut wood and may include a relatively wide flat blade 310. Blade 310 has a pair of cutting faces 312 formed at the distal end thereof. The cutting faces 312 typically extend from the side edges of cutting head 306 to a centering or pilot point 316 located along the longitudinal axis A-A of the drill bit. In the illustrated embodiment the centering point 316 is a lead point 318 having substantially straight cutting edges 318a formed on opposite sides of lead point 318 for boring a pilot hole in the material being drilled to center and guide the bit. The lead point 318 may be replaced by a screw point as shown in FIGS. 1 and 3. The lead point may also be made detachable as previously described. Cutting faces 312 are formed with a bevel angles to create sharp cutting edges 312a for cutting the material as the bit rotates.

The drill bit is formed of at least two different portions made of different materials permanently joined together to create a unitary, single piece drill bit. The first portion 320a is formed of a first material such as 1065 carbon steel. The first portion 320a extends from the proximal end 322 of the bit to a weld line 324. The second portion 320b is formed of a second material such as high speed steel (HSS). The second portion 320b extends from the distal end 326 of the bit to weld line 324 and includes the cutting edges 312a and centering point 316. In one embodiment the weld line 324 is located in a central portion of the cutting head 306 such that a first portion of the blade 310 is formed of the first material and a second portion of the blade 310 is formed of the second material. In one embodiment the second material that includes the cutting edges and centering point is harder and/or stronger than the first material. While weld line 324 is shown in FIG. 5 to illustrate the weld between the first portion 320a and second portion 320b, the transition between these portions is smooth, uniform and uninterrupted such that the first portion transitions smoothly into the second portion.

Drill bits constructed as described above may be used in any wood boring application but are particularly suitable in applications where the drill bit may contact obstructions in the wood such as buried nails, screws, other fasteners or other foreign bodies including metal objects. Drill bits made in accordance with the invention have been found to be over four times more durable than existing carbon steel wood bits while being inexpensive enough for use as wood boring tools. For example, a carbon steel bit will become ineffective for drilling wood after encountering one to two dozen buried nails. The drill bit of the invention is able to bore through over one hundred buried nails and still be effective for cutting holes in pine 2×4 studs.

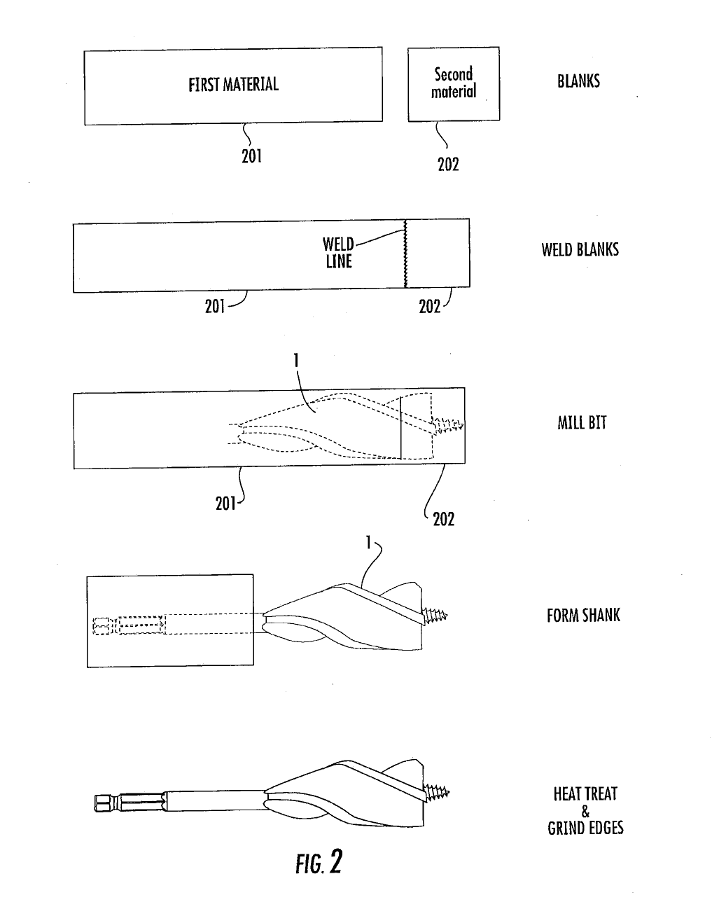

Referring to FIGS. 2 and 5 the process for making the bi-metal drill bit will be described. In one embodiment a cylindrical blank 201 of the first material and a cylindrical blank 202 of the second material are provided (block 501). While in one embodiment the blanks are cylindrical, blanks having other shapes may be used. Blank 201 is welded to a blank 202 to create a bi-metal blank (block 502). Any suitable welding technique may be used including electric, brazing, spin, induction or resistance. The shank is typically formed by turning the blanks on a lathe (block 503). After the blanks are welded together, the flutes and centering point are milled into the combined blanks (block 504). The flutes may be milled into both materials in a single milling operation. The weld line is located in a center portion of the cutting head such that the cutting head has a portion made of the first material and a portion made of the second material. The transition between the material of the first portion and the material of the second portion is smooth and uniform such that the joint between the two materials does not create an obstruction or irregularity on the surface of the bit. After the milling operation the entire bit is heat treated to harden the material of the bit (block 505). After heat treatment the bit is ground to a true diameter and sharp cutting edges are ground into the cutting head (block 506).

While the process for manufacturing the bit has been described with respect to the bit of FIG. 1, the process may be used with bits having different configurations. Further, while three such bit configurations are shown, the bi-metal construction may be provided on any wood bit configuration.

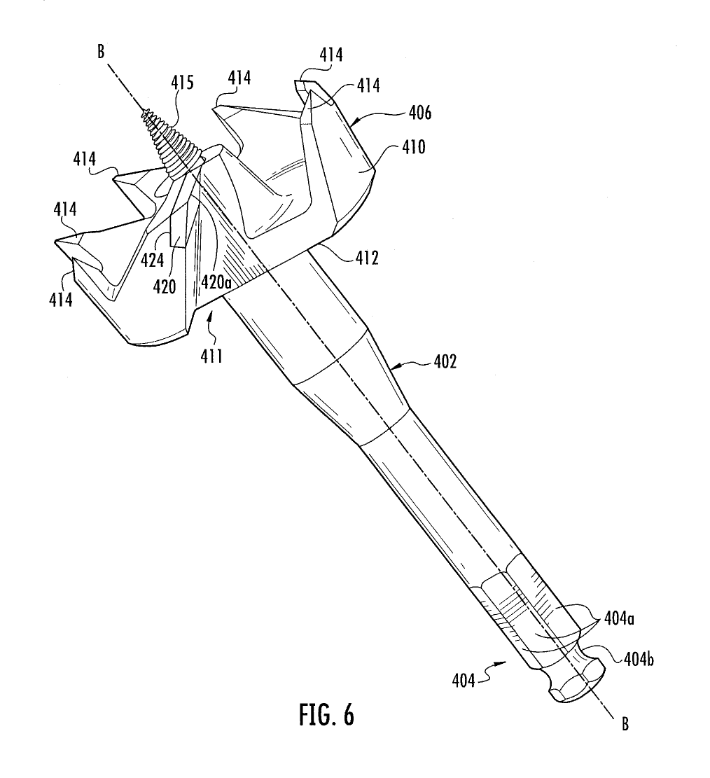

Referring to FIG. 6 another embodiment of the drill bit is shown comprising a shank 402 having a quick coupling 404 disposed at a first end thereof defining the rotational axis B-B of the bit. The quick connect coupling 404 may comprise a plurality flat faces 404a adapted to be received and retained in a chuck of a rotary tool such as a power screwdriver, drill or other power driver. A recess 404b may be formed around the circumference of the shank to be releasably engaged by the quick connect coupler of the rotary tool. Other configurations of shank 402 may also be used for coupling the drill bit to a rotary drive tool.

A generally cylindrical, cup shaped cutting head 406 is formed on the opposite end of shank 402 from quick connect coupling 404. The cutting head 406 comprises an annular wall 410 connected to shank 402 by a base 412. Annular wall 410 defines a circular cutting edge such that as the drill bit rotates the wall circumscribes and cuts a round hole. Formed on the distal edge of the wall 410 are a plurality of teeth 414 that create the cutting edge. When the drill bit 1 is rotated about the rotational axis B-B the teeth 414 score the material being cut to create a clean cut around the periphery of the hole being drilled. A centering point such as screw tip 415 is formed along the rotational axis B-B of the bit that engages the material being cut to feed the bit through the material. The screw tip 415 may be made removable from the remainder of the bit such as by engaging a stem of the screw by a set screw or by providing external screw threads on tip 415 that threadably mate with internal screw threads on the bit.

A cutting blade or lifter 420 having a sharp cutting edge 420a is formed on the cutting head 406. When the drill bit is rotated, the cutting blade 420 lifts the material from the interior of the hole being drilled. The cutting blade 420 extends from adjacent the screw tip 415 to the edge of the blade adjacent the cutting edge formed by teeth 414 such that all of the material inside of the cutting edge is removed. The wall 410 is interrupted in the area in front of the cutting blade 420 to create an open area 411 for allowing ejection of the cut material.

The drill bit 402 is formed of at least two different portions made of different materials permanently joined together to create a unitary, single piece drill bit. The first portion that may include the entire bit except for the cutting blade 420 is formed of a first material such as 1065 carbon steel. The second portion includes the cutting blade 420 and is formed of a second material such as high speed steel (HSS). The second material that includes the cutting edge is harder and/or stronger than the first material. While weld line 424 is shown in FIG. 6 to illustrate the joint between the first portion and second portion, the transition between these portions is smooth, uniform and uninterrupted such that the first portion transitions smoothly into the second portion. The screw tip 415 may also be formed of the second material.

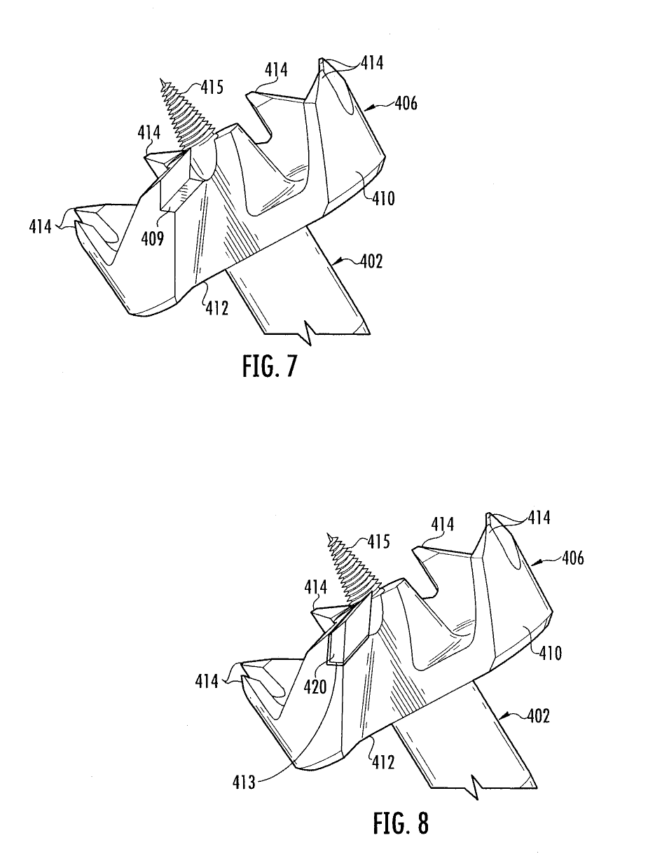

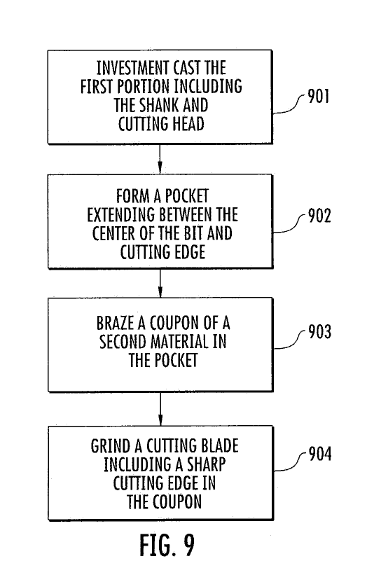

Referring to FIGS. 6 through 9, in one embodiment the drill bit is made using investment cast blanks made of a medium alloyed carbon steel that can be heated to approximately 35 HRC for the shank 402 and cutting head 406, block 901. A pocket 409, FIG. 7, is formed that extends between the center of the bit and the cutting edge for receiving the cutting blade 420, block 902. The cutting blade 420 is formed of a higher alloy steel capable of achieving approximately 60 HRC with HSS preferred. One method of attaching the cutting blade 420 to the cutting head 406 comprises brazing a HSS coupon 415, FIG. 8, onto the carbon steel body in the pocket 409, block 903. A filler alloy 413 is used to join the HSS coupon to the carbon steel body where the filler alloy uses silver and or copper as the main ingredients. The HSS cutting blade 420 is then sharpened into the coupon 411, such as by grinding, to create a sharp cutting edge 420a, block 904.

While embodiments of the invention are disclosed herein, various changes and modifications can be made without departing from the spirit and scope of the invention. One of ordinary skill in the art will recognize that the invention has other applications in other environments. Many embodiments are possible. The following claims are in no way intended to limit the scope of the invention to the specific embodiments described above.

1. A drill bit comprising;
a shank defining a rotational axis;
a cutting head formed at one end of the shank comprising a cylindrical member having an annular wall defining a circular cutting edge including a plurality of teeth;
a screw tip formed along the rotational axis;
a cutting blade having a sharp cutting edge extending from adjacent the centering point to adjacent the cutting edge;
wherein the cutting head is formed of a first material and the cutting blade is formed of a second material, said second material being harder than the first material, said cutting blade being brazed to said cutting head.

2. The drill bit of claim 1 wherein said shank and said cutting head is investment cast.

3. The drill bit of claim 2 wherein said cutting head is made of an alloyed carbon steel that can be heated to approximately 35 HRC.

4. The drill bit of claim 1 wherein a pocket is formed in the cutting head for receiving the cutting blade.

5. The drill bit of claim 1 wherein the cutting blade is formed of an alloyed steel capable of achieving approximately 60 HRC.

6. The drill bit of claim 5 wherein the cutting blade is HSS.

7. The drill bit of claim 1 wherein a filler alloy joins the cutting blade to the cutting head.

8. The bit of claim 1 wherein a smooth transition is provided between the first material and the second material.

9. A method making a drill bit comprising:
investment casting a shank and a cutting head of a first material, said cutting head comprising a cylindrical member having an annular wall defining a circular cutting edge including a plurality of teeth;
forming a pocket that extends to the cutting edge;
brazing a coupon of a second material in said pocket on the carbon steel body;
grinding a sharp edge in said coupon.

10. The method of claim 9 wherein a filler alloy is used to join the coupon to the cutting head.

11. The bit of claim 9 further providing a smooth transition between the first material and the second material.

12. The drill bit of claim 9 making said cutting head of an alloyed carbon steel that can be heated to approximately 35 HRC.

13. The drill bit of claim 9 forming a pocket in the cutting head for receiving the cutting blade.

14. The drill bit of claim 9 making the cutting blade an alloyed steel capable of achieving approximately 60 HRC.

15. The drill bit of claim 9 wherein the second material is HSS.
